(19) United States
(12) Patent Application Publication
(10) Pub. No.: US 2019/0322019 A1
(43) Pub. Date: Oct. 24, 2019

(54) METHOD FOR PRODUCING A FUNCTIONALIZED, THREE-DIMENSIONAL MOLDED BODY

(71) Applicant: BASF SE, Ludwigshafen am Rhein (DE)

(72) Inventors: Michael Kalbe, Ludwigshafen (DE); Claus Dallner, Hong Kong (HK); Rainer Scheidhauer, Ludwigshafen (DE); Alex Horisberger, Ludwigshafen (DE)

(21) Appl. No.: 16/314,188

(22) PCT Filed: Jun. 22, 2017
(86) PCT No.: PCT/EP2017/065434

§ 371 Date: Dec. 28, 2018

(30) Foreign Application Priority Data
Jun. 30, 2016 (EP) 16177087.0

(51) Int. Cl. B29C 45/14; B29C 45/00; B29C 70/46; B29C 70/68; B29C 70/74

(52) U.S. Cl. CPC B29C 45/14786; B29C 45/0005; B29C 70/46; B29K 2063/00; B29C 70/682; B29C 70/74; B29C 45/1418

(57) ABSTRACT

Described herein is a process for the production of a functionalized, three-dimensional molding in a mold made of a composite including at least one fiber material, at least one compound V1 and at least one compound V2, where the compounds V1 and V2 crosslink with one another via reaction in the mold and thus harden to give a thermoset. Also described herein are the functionalized, three-dimensional molding per se, and use thereof by way of example in motor-vehicle construction and/or in the furniture industry.

The present invention relates to a process for the production of a functionalized, three-dimensional molding in a mold made of a composite comprising at least one fiber material, at least one compound V1 and at least one compound V2, where the compounds V1 and V2 crosslink with one another via reaction in the mold and thus harden to give a thermoset. The present invention further relates to the functionalized, three-dimensional molding per se, and also to use thereof by way of example in motor-vehicle construction and/or in the furniture industry.

Natural-fiber moldings are used in the automobile industry by way of example as support material for the decorative material in the construction of doors. Known production processes are hot pressing of cold materials (for example fiber composites), and also cold pressing of preheated materials.

DE-A 199 48 664 discloses a process in which plastic is injected around a fiber mat in an injection mold, where one of the surfaces of the fiber mat is fixed in contact with a first mold half of the injection mold and then a plastics material is introduced into the space between the fiber mat and the second mold half of the injection mold. However, the process of DE-A 199 48 664 does not use a composite material for molding, but instead merely uses a fiber mat per se. Any desired plastic can be used for injection around the fiber mat, and it is also impossible to discern the temperatures at which the individual steps are implemented.

WO 2013/030103 discloses a process for the production of moldings made of a fiber-reinforced polymer, comprising the following steps: (a) insertion of a fiber structure into a mold and injecting a polymer-precursor compound around the fiber structure, or saturation of a fiber structure by a polymer-precursor compound and insertion of the saturated fiber structure into a mold, where the viscosity of the polymer-precursor compound is at most 2000 mPas, (b) polymerization of the polymer-precursor compound to give the polymer for the production of the molding, (c) removal of the molding from the mold as soon as polymerization has proceeded at least to the extent that the molding is in essence dimensionally stable. The process of WO 2013/030103 uses polymer-precursor compounds from which a thermoplastic or thermoset polymer is produced via polymerization molds. However, nowhere in that document is there any disclosure that, before the fiber material used therein is inserted into a heated mold, compounds that can harden to give a thermoset must have been provided thereto, and that an additional functionalization step is then implemented by using an injection-molding polymer on the three-dimensional molding produced in the mold.

WO 2012/116947 discloses processes for the production of semifinished fiber-reinforced sheet products on polyamide matrix, comprising the following steps: (a) use of a mixture comprising molten lactam, catalyst and optionally activator to impregnate textile structures, (b) cooling of the impregnated textile structures, (c) cutting-to-size of the cooled textile structures to give the semifinished fiber-reinforced sheet product. WO 2012/116947 moreover also relates to a process for the production of a component made of the semifinished fiber-reinforced sheet product via press-molding of the semifinished product and heating of the mold, where the lactam polymerizes to give polyamide. However, the process of WO 2012/116947 uses no compounds that can harden to give a thermoset. That document moreover does not disclose that the components produced from semifinished fiber-reinforced sheet products can be functionalized with injection molding polymers.

EP-A 2 596 943 discloses a process for the production of fiber-composite moldings comprising (i) a thermally crosslinkable fiber-composite layer as supportive layer, and (ii) a thermoplastic fiber-composite layer as outer layer, where the fiber-composite layer (i) comprising a thermally crosslinkable binder in the unhardened state and the thermoplastic outer layer (ii) are mutually superposed and, in a molding press, are converted to the desired form and thermally crosslinked, wherein the temperature of the first contact area of the molding press that comes into contact with the supportive layer is higher than that of the second contact area of the molding press that comes into contact with the outer layer. However, nowhere in EP-A 2 596 943 is there any disclosure that the resultant fiber and moldings can be subjected to functionalization with an injection-molding polymer. Nor does that document say that the thermally crosslinkable fiber-composite layer must be inserted into a previously heated mold.

DE-A 10 2011 005 350 discloses a device and a process for the production of a molding with fiber-reinforced support made of thermoplastic or thermoset material and at least one plastic-containing add-on part bonded thereto. In the process of DE-A 10 2011 005 350 it is therefore in principle possible that a thermoset that has already hardened completely, or a thermoplastic material, is set in the fiber-reinforced support before the fiber-reinforced support is molded by pressing. The support material used is generally preheated outside of the mold before it is inserted into the mold. However, in DE-A 10 2011 005 350 there is no disclosure that the support material must be inserted into a mold that has already been heated.

T. Pfefferkorn et al. (“Vom Laminat zum Bauteil” [From laminate to component], Kunststoffe December 2013; Karl Hanser Verlag, Munich), describe a process for the production of continuously reinforced thermoplastics. The process begins by heating, outside of a forming mold, composite test specimen/laminates impregnated with polymers or with polymer-precursor compounds, this being then followed, within said forming mold (injection mold), by the forming of the laminate to give the molding, and also injection of a thermoplastic around the resultant molding.

Another process for the production of functionalized, three-dimensional moldings injects ribs and linkage points directly onto the compression-molded support while it is still hot. Starting material here is provided by hybrid nonwoven fabrics which are produced from thermoplastic fibers and reinforcing fibers (see http://media.daimlercom/dcmedia/0-921-614316-49-1614580-1-0-1-0-0-0-13471-0-0-1-0-0-0-0-0.html, page retrieved on: Sep. 17, 2014). However, the article does not disclose that the starting materials used also comprise compounds that can be hardened to give a thermoset. Nor does that document disclose that the starting materials used must be used in a mold that has already been heated.

The object underlying the present invention consists in the provision of a novel process for the production of functionalized, three-dimensional moldings and to the moldings per se.

The object is achieved via a process for the production of a functionalized, three-dimensional molding made of a composite in a mold, where the process comprises the following steps a) to d):

a) insertion of the composite into the mold, where the composite comprises at least one fiber material, at least one compound V1 and at least one compound V2, and the temperature of the composite on insertion is in the range from 15 to 40° C.,

b) molding of the composite to give a three-dimensional molding in the mold,

c) functionalization of the composite or of the three-dimensional molding via injection of at least one injection-molding polymer onto the material in the mold and

d) removal of the functionalized, three-dimensional molding from the mold,

wherein the compounds V1 and V2 harden to give a thermoset via crosslinking in the mold, and the temperature of the mold at least in the steps a) and b) is mutually independently in the range from 80° C. to 180° C., where

i) step c) is begun during implementation of step b), or

ii) step c) is begun only after step b) has ended.

A substantial advantage of the process of the invention derives from the fact that it is no longer necessary, before the molding procedure, to heat the composite outside of the appropriate mold, as is conventional in the prior art. Instead, the finished composite is placed directly into a preheated mold. Because the composite used as starting material also comprises, alongside fiber material, compounds that can be hardened to give a thermoset, it is easily possible to produce three-dimensional moldings with high thermal stability.

The step of molding of the three-dimensional molding can be followed directly by the functionalization of said molding via injection of at least one injection-molding polymer onto the material in the mold, without any need to interrupt the process. Alternatively, the functionalization can also be begun simultaneously with the molding step or during implementation thereof. This flexibility in respect of the sequence of implementation of the steps b) and c), and also the time saving that may be associated therewith, are further advantages of the process of the invention. Finally, the process of the invention increases the thermal stability of the functionalized, three-dimensional molding by improving the thermomechanical properties of the composite.

It is also simultaneously possible by this process to achieve better mechanical properties which permits production of lighter functionalized, three-dimensional moldings, or else permits production of functionalized, three-dimensional moldings which have unchanged weight but greater stability.

A further advantage of this process is a production cost reduction, because a plurality of processes and/or steps are combined in a mold.

This process also saves time (and thus money), because there is no need to change the location of the respective intermediate product in the individual steps.

A further advantage of the use of compounds that can be hardened to give a thermoset arises from improved thermomechanical properties: functionalized, three-dimensional moldings produced by this process are suitable for use in motor vehicle construction and/or in the furniture industry, in particular in the insolation region of a motor vehicle, for example in door-support modules, parcel shelves, dashboards or armrests near a window of a motor vehicle.

In contrast to the above, thermoplastics have very little suitability for the application sectors described above, and can be used only at relatively low temperatures. Materials exposed to relatively high temperatures, for example resulting from solar radiation, in particular require high melting points in order to avoid progressive deformation.

There is also a significant difference between the processing of thermosets and the processing of thermoplastically hardenable materials in shaping processes. The general procedure for composites based on thermoplastics is that they are heated before the molding step until they melt, and are further processed in an unheated mold, where the melt cools and solidifies. Because thermoplastics are unlike thermosets in having deformability that can be reversible with varying temperature, an important factor in processes for the production of thermoplastically hardenable materials is that the temperature of the appropriate mold during demolding, i.e. the removal of the molding from the mold, is below the melting point of the thermoplastics. Results of a higher temperature during demolding would be that the thermoplastic molding becomes distorted and cannot then retain its correct shape when removed from the mold.

The meanings attributed to “thermoset” and “hardening to give a thermoset” for the purposes of the present invention are the following. Thermosets are obtainable via hardening of the appropriate starting materials. The starting materials used for production of a thermoset via hardening generally comprise at least two different components. The first component is often a polymer or optionally the appropriate monomers from which the respective polymer can be formed. The second component is also termed crosslinking agent, and reacts chemically with the first component, thus bringing about crosslinking of the first component, preferably of polymer chains. Preference is given to three-dimensional crosslinking. Thermosets thus form, after the hardening procedure, a stable structure which is very resistant to deformation.

The meaning of “thermoplastics” for the purposes of the present invention is the following. Thermoplastics, also called plastomers, are polymeric plastics which can be (thermoplastically) deformed within a certain temperature range. This procedure is in principle reversible, i.e. can be repeated many times via cooling and reheating to give the molten state.

Further details are provided below of the process of the invention for the production of functionalized, three-dimensional moldings made of a composite comprising at least one fiber material, at least one compound V1 and at least one compound V2, the functionalized three-dimensional moldings of the invention per se, and also the inventive use of these.

The invention firstly provides a process for the production of a functionalized, three-dimensional molding made of a composite in a mold, where the process comprises the steps a) to d).

In step a) the composite is inserted into the mold, where the composite comprises at least one fiber material, at least one compound V1 and at least one compound V2, and where the temperature of the mold is from 80° C. to 180° C. The meaning of temperature of the mold for the purposes of the present application is that those regions of the mold that come into contact with the composite comply with the temperature range mentioned in the steps a) to d).

Composites (composite materials) are known to the person skilled in the art. A composition comprises at least two components, and preferably has properties different from those of its individual components. The composite of the invention comprises at least one type of fiber, one compound V1 and one compound V2 (as defined below). The composite used in step a) can optionally also comprise other components. The composite can by way of example be produced in that the fiber material is impregnated and/or coated with the compounds V1 and V2 by methods known to the person skilled in the art.

The geometry of the composite can in principle be as desired; it is preferable to use a planar composite. Planar composites are also termed two-dimensional composites or fleeces. The meaning of “planar” in this context is that in relation to the 3 spatial directions of a Cartesian coordinate system (x-direction, y-direction and z-direction) the appropriate composite can assume significantly greater values in 2 spatial directions (dimensions) than in the third spatial direction. This type of composite can by way of example exhibit respective values of from 10 cm to 2 m in its x-direction (length) and in its y-direction (width). The dimension in z-direction (thickness or height) of this type of planar composite is, in contrast to the above, significantly smaller, for example by a factor of 10 or 100, and can be in the range from a few millimeters to centimeters.

It is preferable that step a) uses a planar composite, or at least a substantially planar composite; it is particularly preferable to use a planar composite where each of the sides of the fiber material has been cut-to-size in accordance with the three-dimensional shape to be achieved.

The temperature of the composite in step a) both before insertion into the mold and during insertion into the mold is in the range from 15 to 40° C., preferably in the range from 20 to 30° C., particularly preferably in the range from 23 to 28° C. and in particular is 25° C.

Fiber material that can be used in the invention is in principle any of the fibers known to the person skilled in the art. The fiber material used can take the form of mixture of individual fibers or of fiber bundle. It is possible that the fibers used here are always identical, but it is also possible that mixtures of two or more different types of fiber are used. Examples of these different types of fiber are listed below.

The at least one fiber material can by way of example comprise natural fibers, preferably lignocellulose-containing fibers, particularly preferably fibers made of wood, fibers made of bast, floral fibers and mixtures of these fibers. Suitable fibers made of bast comprise by way of example fibers made of kenaf, flax, jute or hemp, and mixtures of these fibers. Cotton is an example of suitable floral fibers.

The natural fibers can optionally be combined with synthetic fibers, preferably fibers made of polyesters, for example polyethylene terephthalate (PET), Bi—Co fibers made of PET copolyester, fibers made of polyamide (PA), fibers made of polypropylene (PP), or a mixture of these fibers.

It is preferable for the purposes of the present invention to use a fiber material based on natural fibers with admixed synthetic fibers. The proportion of admixed synthetic fibers is preferably <30% by weight, with preference <20% by weight, based on the total weight of the fiber material.

The proportion of the at least one fiber material in the composite is preferably at least 50% by weight, particularly preferably at least 60% by weight, very particularly preferably at least 70% by weight, based on the weight of the composite.

The composite in the present invention moreover comprises at least one compound V1 and at least one compound V2. The compounds V1 and V2 per se are known to the person skilled in the art, for example from EPA 2596943.

For the purposes of this application, the compounds V1 and V2 are any of the compounds from which it is possible to produce a thermoset (i.e. which can harden together to give a thermoset). To this end, compound V1 preferably has at least three reactive pendant groups and compound V2 is preferably a compound having at least two reactive pendant groups which can react with the reactive pendant groups of compound V1.

The compounds V1 and V2 are compounds differing from one another, and therefore a compound covered by the definition of a compound V1 is not covered by the definition of a compound V2 and vice versa. However, it is possible that, mutually independently, a plurality of (for example two or three) different compounds V1 and/or V2 are used.

The proportions of the compounds V1 and V2 in the composite preferably give a total of at most 70% by weight, particularly preferably at most 50% by weight, very particularly preferably at most 30% by weight, based on the weight of the composite.

With greater preference, the compound V1 is a polymer having reactive pendant groups and the compound V2 is a low-molecular-weight compound which can react with the reactive pendant groups of the polymer of compound V1. The reactive pendant groups of the compound V1 are preferably acid groups or epoxy groups. The molar mass of the low-molecular-weight compound (compound V2) is preferably 200 g/mol, in particular 150 g/mol. The compound V2 is also termed crosslinking agent, and is preferably a polyol, in particular triethanolamine, a polyamine, a polyepoxide or a polycarboxylic acid.

With greater preference, the compound V1 is a polymer based on acrylic acid, on methacrylic acid, on styrene/acrylic acid copolymers, on styrene/methacrylic acid copolymers, or on maleic acid, or is a polymer based on alkali metal salts or esters of acrylic acid or methacrylic acid, for example (meth)acrylates and on styrene/(meth)acrylate copolymers, or is a polymer based on formaldehyde resins, on polyesters, on epoxy resins or on polyurethanes.

It is particularly preferable that the compound V1 is an acrylic acid/styrene/acrylate copolymer.

Examples of preferred formaldehyde resins are urea formaldehyde resins (UF resins), phenol formaldehyde resins (PF resins), melamine formaldehyde resins (MF resins) and melamine urea formaldehyde resins (MUF resins). The abovementioned compounds V1, preferably the abovementioned polymers, can also be used in the form of dispersions, preferably in the form of aqueous dispersions.

Preference is further given to use of the compound V1 and V2 in the form of mixtures. These mixtures are also termed binders and are by way of example obtainable commercially as Acrodur® (BASF SE). The compounds V1 and V2, or mixtures of these, can be hardened together to give a thermoset (can be molded to give a thermoset); this is preferably achieved with introduction of heat.

It is moreover possible that the composite comprises not only at least one fiber material, at least one compound V1 and at least one compound V2 but also other constituents, preferably one or more catalysts, suitable catalysts are preferably phosphorus-containing catalysts, in particular sodium hypophosphite.

The mold per se used in the process in the present invention is known to the person skilled in the art. It is preferably a combined compression and injection mold in which by way of example it is possible to carry out molding (press-molding), heating, and also injection of another material (for example a polyamide) onto a first material. To this end, the mold can have not only cavities to receive the composite but also cavities to receive the injection-molding polymer. This type of mold preferably has a plurality of these cavities. It is preferable that some cavities in the mold are not filled by the insertion and/or molding of the composite (steps a) and b)). The injection-molding polymer is preferably introduced into these free cavities in step c). These molds are known to the person skilled in the art. They are disclosed by way of example in DE 10 2011 005 350 A1, EP 2 502 723 A1 or DE 10 2012 022 633 A1.

It is preferable that the mold of the process of the present invention is a combined compression and injection mold for injection-molding polymers; it is particularly preferable that the mold of the process of the present invention is a combined compression and injection mold for thermoplastics.

The temperature of the mold in step a) is preferably from 80° C. to 180° C., more preferably from 85° C. to 120° C.

Before the molding procedure in step b) it is therefore preferable to avoid heating the composite outside of the mold to a temperature that is above 40° C., more preferably above 30° C., particularly preferably above 28° C. and in particular above 25° C., and it is preferable that in step a) the composite is inserted into a mold which, before the insertion of the composite in step a), has been heated to at least 80° C., preferably at least 85° C.

In step b), the composite is subjected to a forming procedure in the mold to give a three-dimensional molding.

The forming procedure per se is known to the person skilled in the art. The forming procedure preferably changes the geometry of the composite, for example by subjecting all, or at least a portion, of this composite to bending. The geometry of the composite thus changes in relation to at least one of the 3 spatial directions of a Cartesian coordinate system. The geometry of the three-dimensional molding resulting from step b) is determined via the shape of the mold. It is preferable that the forming process to which a planar composite is subjected in step b) is such that the dimension values in the z-direction of the appropriate three-dimensional molding becomes higher than the corresponding values for the planar composite, preferably by a factor of at least 2.

The molding of the composite in the mold is preferably press-molding of the composite. Press-molding per se is known to the person skilled in the art.

The temperature of the mold in step b) is in the range from 80° C. to 180° C. The temperature of the mold in step b) is preferably from 85° C. to 160° C., more preferably from 90° C. to 120° C.

In step c), the three-dimensional molding is functionalized by injecting at least one injection-molding polymer onto the material in the mold.

The functionalization per se is known to the person skilled in the art. It preferably means the attachment of desired elements, for example the attachment of ribs for stability and strength, assembly aids, map pockets and the like. These elements are obtained from the injection-molding polymer by injecting material onto the composite or onto the three-dimensional molding composed thereof. It is preferable that the three-dimensional molding of step b) is functionalized in step c).

The injection of a further material per se is likewise known to the person skilled in the art. It is preferable here that elements composed of injection-molding polymer are provided to one or more regions of the surface of the composite or of the three-dimensional molding resulting therefrom. Suitable elements have already been defined in the context of “functionalization”. For the purposes of the present invention, the injection of a further material is preferably implemented in a manner such that in step c) the injection-molding polymer fills free cavities present in the mold. These free cavities determine the specific shaping of the elements which are applied via injection of a further material onto the appropriate surface of the composite or of the three-dimensional molding resulting therefrom.

The injection-molding polymer per se used in step c) is known to the person skilled in the art. The injection-molding polymer is preferably a high-temperature-resistant thermoplastic, for example polyamide (PA), more preferably a thermoplastic with melting point 100° C. With still greater preference, the thermoplastic is selected from polyoxymethylene (POM), polybutylene terephthalate (PBT), polyethylene terephthalate (PET), polyamide 6, polyamide 6.6, polyamide 6.10, polyamide 6.12, polyamide 11 and polyamide 12; the thermoplastic is particularly preferably selected from polyamide 6, polyamide 6.6, polyamide 6.10, polyamide 6.12, polyamide 11 and polyamide 12. These polymers are available commercially by way of example as Ultramid® (BASF SE).

The injection-molding polymer can moreover be modified in that the injection-molding polymer has been reinforced by at most 70% by weight, preferably at most 50% by weight, particularly preferably at most 30% by weight, based on the total weight of the injection-molding polymer, with material selected from glass fibers, carbon fibers, aramid fibers, natural fibers, glass beads and mixtures thereof.

For implementation of the functionalization by injection of a further material, the injection-molding polymer used in step c) is generally in molten form when it is introduced into the mold. It is preferable here that when the injection-molding polymer has been introduced into the mold in step c) it has been heated to a temperature of at least 160° C., preferably to a temperature of at least 250° C., particularly preferably to a temperature of at least 300° C.

The sequence (chronological sequence) of the steps b) and c) is, as already mentioned above, not fixedly defined in the process of the invention, but instead can be selected from the following two options i) and ii): in option i), step c) can be begun during the implementation of step b); in option ii), step c) can be begun only after termination of step b). In the case of both options i) and in particular ii), the functionalization is implemented on a substantially or fully formed three-dimensional molding.

It is preferable in the invention that step c) is begun only after step b) has ended.

In the options i) and ii) it is possible that the duration of steps b) and c) is identical, that step b) has longer duration than step c), or that step c) has longer duration than step b). As already mentioned above, is optionally possible in an option iii) to implement an intermediate step, preferably a temperature-controlled conditioning step, before step c) is begun. The duration of the individual steps b) and/or c) is in principle freely selectable and known to the person skilled in the art. The duration of the individual steps b) and c) is generally sufficient to achieve the desired effect, i.e. in step b) conclusion of the molding of the composite, and in step c) completion of provision of the injection-molding polymer to the locations intended for that purpose on the three-dimensional molding.

Insofar as step c) is begun only after step b) has ended, the temperature of the molding in step c) can in principle assume any desired values. In this scenario it is preferable that the relevant temperature values comply with the temperature range data mentioned above for step b) (inclusive of the preferred values). Insofar as the step c) is begun during the implementation of step b), the temperature of the mold is (necessarily) identical in the two steps until step b) has ended. Once the step b) has ended, the temperature can likewise in principle assume any desired values. It is preferable in this type of case that the temperature is lowered to a temperature in the range from 80 to 160° C. and particularly from 85 to 140° C. and in particular from 90 to 120° C.

In step d), the functionalized, three-dimensional molding is removed from the mold. At this juncture, the functionalized, three-dimensional molding has preferably already hardened completely, but it is also optionally possible that a functionalized, three-dimensional molding that has only partially hardened is removed from the mold in step d). The hardening to give a thermoset can optionally also be continued outside of the mold. The person skilled in the art also uses the term “demolding” for the removal of the functionalized, three-dimensional molding from the mold in step d).

The temperature of the molding in step d) can in principle likewise assume any desired values. However, it is preferable that the relevant temperature values comply with the temperature values selected in step c).

It is moreover possible in the invention that the temperature of the mold varies mutually independently in the steps a) to d). However, it is preferable that the temperature in the steps a) to d) is kept constant.

Step d) can optionally be followed by implementation of further steps, for example further processing of the functionalized, three-dimensional molding in accordance with the desired use.

As already stated above, compound V1 and compound V2 harden in the mold via crosslinking to give a thermoset.

The meaning of crosslinking/crosslink here is crosslinking in one, two, or three dimensions, preference being given here to crosslinking in three dimensions. The crosslinking is irreversible, and the composite or the three-dimensional molding is thus hardened to give a thermoset. The extent of the crosslinking can be controlled via the residence time in the mold and/or the temperature of the mold.

As already mentioned above, the hardening of the compounds V1 and V2 to give a thermoset is achieved via introduction of heat. The heat required for hardening in the invention is transferred to the composite, or to the three-dimensional molding obtained therefrom, or to the functionalized three-dimensional molding, by virtue of the temperature established for the mold in the steps a), b) and/or c).

Between the respective steps it is optionally also possible to implement one or more intermediate steps, for example in that the composite or the three-dimensional molding is exposed to the temperature ranges stated for the mold in the steps a) to c) while no further action is implemented on the composite or on the molding, examples of such action being the molding in step b) and the functionalization in step c). These intermediate steps are also termed temperature-controlled conditioning steps; it is also optionally possible that this type of temperature-controlled conditioning step also follows after the step c) ends.

It is possible in the invention that the hardening to give a thermoset begins/takes place during the insertion of the composite into the heated mold in step a), i.e. as soon as the composite comes into contact with the heat source. Whether, and to what extent, hardening takes place during the step a) is in principle of little importance. The hardening is preferably controlled via the temperature established and/or duration of the steps b) and/or c), and also via likewise preceding, intervening or subsequent temperature-controlled conditioning steps (intermediate steps). It is preferable that the composite or the functionalized three-dimensional molding produced therefrom remains in the mold until hardening to give a thermoset has been substantially, or in particular completely, concluded. The end of the hardening procedure is preferably apparent to the person skilled in the art in that the functionalized three-dimensional molding is no longer amenable to reversible deformation.

It is preferable in the process of the invention that
i) the temperature of the mold in steps a) and b) is mutually independently from 80° C. to 180° C., preferably from 85° C. to 160° C., and/or
ii) the temperature of the mold in steps a) to c) is from 80° C. to 180° C., preferably from 85° C. to 160° C., particularly preferably from 90° C. to 120° C., and/or
iii) at least one additional temperature-controlled conditioning step is implemented before step b), before step c) and/or after step c), where the temperature of the mold is from 80° C. to 180° C., preferably from 85° C. to 160° C., particularly preferably from 90° C. to 120° C.

It is moreover preferable that in the process of the invention the temperature of the mold is kept constant in the steps a) and b), and preferably in the steps a) to d). Insofar as one or more intermediate steps, preferably temperature-controlled conditioning steps, is/are implemented, it is moreover preferable that in those steps again the temperature established is constant and the same as that in the steps a) to d).

A preferred embodiment of the process of the invention comprises the steps a) to d) defined as follows:
a) insertion of the composite into the mold, where the composite comprises an acrylic acid/styrene-acrylate copolymer and a mixture of natural fibers and synthetic fibers, and comprises a polyol, the temperature of the composite is in the range from 15 to 40° C., and the temperature of the mold is from 80° C. to 180° C.,
b) molding of the composite to give a three-dimensional molding in the mold, where the temperature of the mold is from 80° C. to 180° C.,
c) functionalization of the three-dimensional molding in the mold via injection, onto the material, of an injection-molding polymer heated to a temperature of at least 160° C., and
d) removal of the functionalized, three-dimensional molding from the mold,

wherein compound V2 and the polymer based on acrylic acid and/or on styrene/acrylate copolymers crosslink with one another via reaction in the mold and harden to give a thermoset, and step c) is begun only after step b) has ended,

where after step b) and before step c) or during step c) an additional temperature-controlled conditioning step is implemented in which the composite is exposed to a temperature of from 80° C. to 180° C. in the mold.

The present invention further provides three-dimensional, functionalized moldings obtainable via the process of the invention. These three-dimensional, functionalized moldings preferably take the form of motor-vehicle-interior part or take a form that can be used in the furniture industry.

The present invention further provides the use of three-dimensional, functionalized moldings obtainable via the process of the invention in motor vehicle construction and/or in the furniture industry, preferably in the insolation region of a motor vehicle, particularly preferably for door-support modules, parcel shelves, dashboards or armrests near a window of a motor vehicle.

All the definitions established for the process of the invention also apply to the three-dimensional, functionalized moldings and use of these.

The examples below provide further explanation of the present invention, which however is not restricted thereto.

The examples use the following compounds:
Acrodur 2850 X: thermoplastically hardening binder
Acrodur DS 3515: styrene/acrylate dispersion which hardens to give a thermoset, modified with a polycarboxylic acid and with a polyol as crosslinking agent
Acrodur 950 L: solution which hardens to give a thermoset, made of a polycarboxylic acid and of a polyol as crosslinking agent
Ultramid B3WG6: high-temperature-resistant thermoplastic based on polycarprolactam

The examples below were implemented in a system from the Kraus Maffei KM 300-1400 CS range with a GK 10104 combined compression and injection mold.

Composites were preheated for 60 seconds to 180° C. in an IR field.

A) Production of Thermoplastic Moldings I:

A natural-fiber mat made of nonwoven fabric measuring 45×45 cm² is impregnated with a 28% solution of Acrodur 2850 X, and the resultant composite, the temperature of which is T1, is transferred into a compression and injection mold, the temperature of which is T2. The composite is dried at 100° C. to a residual moisture content of <2%, and pressed at 170° C. to a specified thickness of from 1.6 to 1.8 mm within a period of 30 seconds. The composite is then functionalized by injecting Ultramid B3WG6 onto the material.

Examples A1 to A4 produce thermoplastically hardening moldings at various temperatures T1 and T2. Table 1 shows the results.

B) Production of Thermoplastic Moldings II:

A wood-fiber mat measuring 45×45 cm² is impregnated with a 20% solution of Acrodur 2850 X, and the resultant composite, the temperature of which is T1, is transferred into a compression and injection mold, the temperature of which is T2. The composite is dried at 100° C. to a residual moisture content of <2%, and pressed at 170° C. to a specified thickness of from 1.6 to 1.8 mm within a period of 30 seconds. The composite is then functionalized by injecting Ultram id B3WG6 onto the material.

Examples B1 to B4 produce thermoplastically hardening moldings at various temperatures T1 and T2. Table 1 shows the results.

C) Production of Thermoset Moldings Based on Styrene/Acrylate Polymers:

A natural-fiber mat made of nonwoven fabric measuring 45×45 cm² is impregnated with a 50% solution of Acrodur DS 3515, and the resultant composite, the temperature of which is T1, is transferred into a compression and injection mold, the temperature of which is T2. The composite is dried at 100° C. to a residual moisture content of <2%, and is pressed at 110° C. with a pressure of 4 bar to give a specified thickness of from 1.6 to 1.8 mm within a period of 20 seconds. The composite is then functionalized by injecting Ultramid B3WG6 onto the material.

Examples E1 to E4 produce thermoplastically hardening moldings at various temperatures T1 and T2. Table 1 shows the results.

F) Production of Thermoset Moldings Based on Polycarboxylic Acids:

A wood-fiber mat measuring 45×45 cm² is impregnated with a 35% solution of Acrodur 950 L, and the resultant composite, the temperature of which is T1, is transferred into a compression and injection mold, the temperature of which is T2. The composite is dried at 80° C. to a residual moisture content of <2%, and is pressed at 150° C. with a pressure of 5 bar to give a specified thickness of from 1.6 to 1.8 mm within a period of 20 seconds. The composite is then functionalized by injecting Ultramid B3WG6 onto the material.

Examples D1 to D4 produce thermoplastically hardening moldings at various temperatures T1 and T2. Table 1 shows the results.

E) Production of Thermoset Moldings Based on Styrene/Acrylate Polymers:

A natural-fiber mat made of nonwoven fabric measuring 45×45 cm² is impregnated with a 50% solution of Acrodur DS 3515, and the resultant composite, the temperature of which is T1, is transferred into a compression and injection mold, the temperature of which is T2. The composite is dried at 100° C. to a residual moisture content of <2%, and is pressed at 110° C. with a pressure of 4 bar to give a specified thickness of from 1.6 to 1.8 mm within a period of 20 seconds. The composite is then functionalized by injecting Ultramid B3WG6 onto the material.

Examples E1 to E4 produce thermoplastically hardening moldings at various temperatures T1 and T2. Table 1 shows the results.

F) Production of Thermoset Moldings Based on Polycarboxylic Acids:

A wood-fiber mat measuring 45×45 cm² is impregnated with a 35% solution of Acrodur 950 L, and the resultant composite, the temperature of which is T1, is transferred into a compression and injection mold, the temperature of which is T2. The composite is dried at 80° C. to a residual moisture content of <2%, and is pressed at 110° C. with a pressure of 5 bar to give a specified thickness of from 1.6 to 1.8 mm within a period of 20 seconds. The composite is then functionalized by injecting Ultramid B3WG6 onto the material.

Examples F1 to F4 produce thermoplastically hardening moldings at various temperatures T1 and T2. Table 1 shows the results.

G) Production of Thermoset Moldings Based on Styrene/Acrylate Polymers:

A natural-fiber mat made of nonwoven fabric measuring 45×45 cm², where 20% of the fibers present in the natural-fiber mat are fibers made of polyethylene terephthalate, is impregnated with a 50% solution of Acrodur DS 3515, and the resultant composite, the temperature of which is T1, is transferred into a compression and injection mold, the temperature of which is T2. The composite is dried at 100° C. to a residual moisture content of <2%, and is pressed at 150° C. with a pressure of 4 bar to give a specified thickness of from 1.6 to 1.8 mm within a period of 20 seconds. The composite is then functionalized by injecting Ultramid B3WG6 onto the material.

Examples G1 to G4 produce thermoplastically hardening moldings at various temperatures T1 and T2. Table 1 shows the results.

H) Production of Thermoset Moldings Based on Polycarboxylic Acids:

A wood-fiber mat measuring 45×45 cm², where 20% of the fibers present in the natural-fiber mat are fibers made of polyethylene terephthalate, is impregnated with a 35% solution of Acrodur 950 L, and the resultant composite, the temperature of which is T1, is transferred into a compression and injection mold, the temperature of which is T2. The composite is dried at 80° C. to a residual moisture content of <2%, and is pressed at 150° C. with a pressure of 5 bar to give a specified thickness of from 1.6 to 1.8 mm within a period of 20 seconds. The composite is then functionalized by injecting Ultramid B3WG6 onto the material.

Examples D1 to D4 produce thermoplastically hardening moldings at various temperatures T1 and T2. Table 1 shows the results.

The effect of the temperatures T1 of the composite and T2 of the mold on insertion of the composite is decisive for the quality of the final product (see table 1).

The examples indicated by (V) are comparative examples.

Where a mold is termed “preheated” it was preheated to a temperature T2 of from 110 to 115° C. and kept within this temperature range during the production of the moldings.

Where the moldability of products does not comply with the ongoing requirements, the products exhibit cracks and have accordingly been indicated as inadequate in table 1. Products indicated as inadequate are not subjected to further testing for demoldability. Products which are distorted as a result of removal from the injection mold are also indicated as inadequate. Products indicated as inadequate during demolding are not subjected to further testing for heat resistance.

Summary:

Thermoplastically hardening composites (A1 to A4 and B1 to B4) in principle exhibit good moldability irrespective of the temperature of the mold, as long as either the mold or the thermoplastically hardenable composite was heated. However, thermoplastically hardenable composites can be removed from the injection mold without distortion only if this was not heated during demolding (A2 and B2). It is therefore necessary to establish a lower temperature for the injection mold than for the melt of the thermoplastically hardening composite in order that the melt cools and solidifies in the injection mold.

In contrast to the above, composites which harden to give a thermoset can be converted to a three-dimensional form only if they are inserted, without prior heating, into a hot mold (C3, D3). If, before the molding procedure, they are heated and thus converted to their thermoset state, the thermoset composites can then no longer be molded.

Heat Resistance:

For heat-resistance testing of the moldings of the invention, moldings of length 30 cm and of width 5 cm were cut from the processed material of examples A2, B2, C3, D3, E3, F3, G3 and H3. These were placed on two supports separated from one another by 25 cm. A 100 g weight was placed centrally onto the moldings, and this assembly was placed in an oven at 120° C. for 30 minutes. After this time in the oven, the deflection of the molding from horizontal was measured. The molding was considered to be heat-resistant if no deflection of the molding from the horizontal was measured.

Summary:

Composites which harden to give a thermoset (C3, D3, E3, F3, G3 and H3) retain their stability at elevated temperatures (e.g. 120° C.), with no change of shape. The composites of the invention which harden to give a thermoset therefore have excellent suitability for use in sectors including those in which materials have exposure to relatively high temperatures, and which require relatively high melting points of the material.

Thermoplastically hardening composites become deformable again at elevated temperatures, and cannot therefore be used for the same application sectors where the composites of the invention which harden to give a thermoset can be used.

TABLE 1

| Exper- | T1 | T2 | | | Heat |
|---|---|---|---|---|---|
| iment | [° C.] | [° C.] | Moldability | Demoldability | resistance |
| A1 (V) | 25 | 25 | inadequate | — | — |
| A2 (V) | 180 | 25 | good | good | inadequate |
| A3 (V) | 25 | preheated | good | inadequate | — |
| A4 (V) | 180 | preheated | good | inadequate | — |
| B1 (V) | 25 | 25 | inadequate | — | — |
| B2 (V) | 180 | 25 | good | good | inadequate |
| B3 (V) | 25 | preheated | good | inadequate | — |
| B4 (V) | 180 | preheated | good | inadequate | — |
| C1 (V) | 25 | 25 | inadequate | — | — |
| C2 (V) | 180 | 25 | inadequate | — | — |
| C3 | 25 | preheated | good | good | good |
| C4 (V) | 180 | preheated | inadequate | — | — |
| D1 (V) | 25 | 25 | inadequate | — | — |
| D2 (V) | 180 | 25 | inadequate | — | — |
| D3 | 25 | preheated | good | good | good |
| D4 (V) | 180 | preheated | inadequate | — | — |
| E1 (V) | 25 | 25 | inadequate | — | — |
| E2 (V) | 180 | 25 | inadequate | — | — |
| E3 | 25 | preheated | good | good | good |
| E4 (V) | 180 | preheated | inadequate | — | — |
| F1 (V) | 25 | 25 | inadequate | — | — |
| F2 (V) | 180 | 25 | inadequate | — | — |
| F3 | 25 | preheated | good | good | good |
| F4 (V) | 180 | preheated | inadequate | — | — |
| G1 (V) | 25 | 25 | inadequate | — | — |
| G2 (V) | 180 | 25 | inadequate | — | — |
| G3 | 25 | preheated | good | good | good |
| G4 (V) | 180 | preheated | inadequate | — | — |
| H1 (V) | 25 | 25 | inadequate | — | — |
| H2 (V) | 180 | 25 | inadequate | — | — |
| H3 | 25 | preheated | good | good | good |
| H4 (V) | 180 | preheated | inadequate | — | — |

1. A process for the production of a functionalized, three-dimensional molding made of a composite in a mold, wherein the process comprises the following steps a) to d):
a) insertion of the composite into the mold, wherein the composite comprises at least one fiber material, at least one compound V1 and at least one compound V2, and the temperature of the composite on insertion is in the range from 15 to 40° C.;
b) molding of the composite to give a three-dimensional molding in the mold;
c) functionalization of the composite or of the three-dimensional molding via injection of at least one injection-molding polymer onto the material in the mold; and
d) removal of the functionalized, three-dimensional molding from the mold,
wherein the compounds V1 and V2 harden to give a thermoset via crosslinking in the mold, and the temperature of the mold at least in the steps a) and b) is mutually independently in the range from 80° C. to 180° C., wherein
i) step c) is begun during implementation of step b), or
ii) step c) is begun only after step b) has ended.

2. The process according to claim 1, wherein the at least one fiber material comprises natural fibers,
wherein the natural fibers can optionally be combined with synthetic fibers.

3. The process according to claim 1, wherein the compound V1 has at least one reactive pendant group and the compound V2 is a compound which can react with the reactive pendant group of compound V1.

4. The process according to claim 1, wherein compound V1 is a polymer based on acrylic acid, on methacrylic acid, on styrene/acrylic acid copolymers, on styrene/methacrylic acid copolymers, or on maleic acid, or is a polymer based on alkali metal salts or esters of acrylic acid or methacrylic acid, and on styrene/(meth)acrylate copolymers, or is a polymer based on formaldehyde resins, on polyesters, on epoxy resins or on polyurethanes, and/or compound V2 is a polyol, polyamine, polyepoxide or polycarboxylic acid.

5. The process according to claim 1, wherein:
i) the temperature of the mold in steps a) and b) is mutually independently from 80° C. to 180° C., and/or
ii) the temperature of the mold in steps a) to c) is from 80° C. to 180° C., and/or
iii) at least one additional heating step is implemented before step b), before step c) and/or after step c), wherein the temperature of the mold is from 80° C. to 180° C.

6. The process according to claim 1, wherein:
i) the proportion of the at least one fiber material in the composite is at least 50% by weight, based on the weight of the composite, and/or
ii) the proportions of the compounds V1 and V2 in the composite together are at most 70% by weight, based on the weight of the composite.

7. The process according to claim 1, wherein:
i) the temperature of the mold in steps a) and b), is kept constant or varies by no more than 5° C., and/or
ii) the temperature of the composite on insertion into the mold in step a) is in the range from 20 to 30° C., and/or
iii) the reactive pendant groups of compound V1 are acid groups or epoxy groups, and/or
iv) the composite comprises not only at least one fiber material, at least one compound V1 and at least one compound V2 but also other constituents, and/or
v) the process carried out on the composite in step b) takes the form of press-molding, and/or
vi) step c) is begun only after step b) has ended.

8. The process according to claim 1, wherein the mold is a combined compression and injection mold.

9. The process according to claim 1, wherein when the injection-molding polymer is introduced into the molding in step c) it has been heated to a temperature of at least 160° C.

10. The process according to claim 1, wherein the injection-molding polymer is a high-temperature-resistant thermoplastic with melting point above 100° C.

11. The process according to claim 1, wherein the injection-molding polymer has been reinforced by at most 70% by weight, based on the total weight of the injection-molding polymer, with material selected from glass fibers, carbon fibers, aramid fibers, natural fibers, glass beads and mixtures thereof.

12. The process according to claim 1, wherein the steps a) to d) are defined as follows:
a) insertion of the composite into the mold, wherein the composite comprises a polymer based on acrylic acid and/or on styrene/acrylate copolymers, and comprises a polyol and a mixture of natural fibers and synthetic fibers, the temperature of the composite is in the range from 15 to 40° C., and the temperature of the mold is from 80° C. to 180° C.;
b) molding of the composite to give a three-dimensional molding in the mold, wherein the temperature of the mold is from 110° C. to 150° C.;
c) functionalization of the three-dimensional molding via injection, onto the material, of an injection-molding polymer heated to a temperature of at least 160° C., in the mold; and
d) removal of the functionalized, three-dimensional molding from the mold,
wherein the polyol and the polymer based on acrylic acid and/or on styrene/acrylate copolymers crosslink with one another via reaction in the mold and harden to give a thermoset, and step c) is begun only after step b) has ended, and
wherein after step b) and before step c) or during step c) an additional temperature-controlled conditioning step is implemented in which the composite is exposed to a temperature of from 80° C. to 180° C. in the mold.

13.-15. (canceled)

16. The process according to claim 2, wherein the at least one fiber material comprises lignocellulose-containing fibers, and
wherein the optional synthetic fibers comprise fibers made of polyesters or copolyesters, Bi—Co fibers made of polyethylene terephthalate copolyester, fibers made of polyamide (PA), fibers made of polypropylene (PP), or a mixture of these fibers.

17. The process according to claim 3, wherein the compound V1 is a polymer having reactive pendant groups, and the compound V2 is a low-molecular-weight compound that can react with the reactive pendant groups of the polymer of compound V1.

18. The process according to claim 5, wherein:
i) the temperature of the mold in steps a) and b) is mutually independently from 85° C. to 160° C., and/or
ii) the temperature of the mold in steps a) to c) is from 85° C. to 160° C., and/or
iii) at least one additional heating step is implemented before step b), before step c) and/or after step c), wherein the temperature of the mold is from 85° C. to 160° C.

19. The process according to claim 6, wherein:
i) the proportion of the at least one fiber material in the composite is at least 60% by weight, based on the weight of the composite, and/or
ii) the proportions of the compounds V1 and V2 in the composite together at most 50% by weight, based on the weight of the composite.

20. The process according to claim 7, wherein the temperature of the mold in a) to d) is kept constant or varies by no more than 5° C.

21. The process according to claim 7, wherein the composite comprises the other constituents comprising one or more catalysts.

22. The process according to claim 10, wherein the injection-molding polymer is selected from polyoxymethylene (POM), polybutylene terephthalate (PBT), polyethylene terephthalate (PET), polyamide 6, polyamide 6.6, polyamide 6.10, polyamide 6.12, polyamide 11 and polyamide 12 particularly preferably from polyamide 6, polyamide 6.6, polyamide 6.10, polyamide 11, and polyamide 12.

23. The process according to claim 11, wherein the injection-molding polymer has been reinforced by at most 50% by weight, based on the total weight of the injection-molding polymer, with material selected from glass fibers, carbon fibers, aramid fibers, natural fibers, glass beads and mixtures thereof.
